(19) United States
(12) Patent Application Publication
(10) Pub. No.: US 2026/0050556 A1
(43) Pub. Date: Feb. 19, 2026

(54) METHOD OF REPLACING DATA IN CACHE MEMORY AND CACHE DATA REPLACEMENT SYSTEM PERFORMING THE SAME

(71) Applicant: SAMSUNG ELECTRONICS CO., LTD., Suwon-si (KR)

(72) Inventors: Youngsik Lee, Suwon-si (KR); Tae Hee Han, Seoul (KR); Jeonghun Kim, Hwaseong-si (KR); Hojung Yoo, Seoul (KR)

(73) Assignee: RESEARCH & BUSINESS FOUNDATION SUNGKYUNKWAN UNIVERSITY, Suwon-si (KR)

(21) Appl. No.: 19/085,980

(22) Filed: Mar. 20, 2025

(30) Foreign Application Priority Data
Aug. 16, 2024 (KR) 10-2024-0109843

(51) Int. Cl. G06F 12/126; G06F 12/0895; G06F 12/123

(52) U.S. Cl. CPC G06F 12/126; G06F 12/0895; G06F 12/123

(57) ABSTRACT

In an example method of replacing data in a cache memory, input data is received. A set competition priority value is determined based on a set-access-count-since-last-miss (SALM) counter value. A cache line recency priority value is determined based on a preuse distance value. A tag bit priority value is determined based on a first tag-bit-subset-array (TBSA) and a second TBSA. A first reference value is calculated based on the set competition priority value, the cache line recency priority value, and the tag bit priority value. A tag-age-based policy is performed based on the first reference value. The tag-age-based policy represents an operation that replaces first cache data stored in a first way among a plurality of target ways with the target data.

### CROSS-REFERENCE TO RELATED APPLICATION

This application claims priority under 35 USC § 119 to Korean Patent Application No. 10-2024-0109843 filed on Aug. 16, 2024 in the Korean Intellectual Property Office (KIPO), the contents of which are herein incorporated by reference in their entirety.

### BACKGROUND

In processor design, both performance of computational units and performance of memory devices may be important factors. Typically, parallel computational units and memory devices with a hierarchical structure may be used for the processor to achieve such factors. As the performance of the processor improves, the importance of a cache memory to reduce bottlenecks the processor cores and a main memory increases.

The cache memory is a high-speed memory located between the processor and the main memory, and operates with a speed corresponding to the processor. The cache memory may store a part of data stored in the main memory, and data stored in the cache memory may be accessed faster than the data stored in the main memory. The bottlenecks caused by the speed difference between the processor with high speed and the main memory with low speed may be reduced by the cache memory.

A cache management is essential to efficiently use the cache memory. A cache replacement policy is one of cache management schemes, and various methods are being studied to efficiently replace cache data.

### SUMMARY

The present disclosure relates to a method of efficiently replacing data in a cache memory and a cache data replacement system performing the method of efficiently replacing data in the cache memory.

In general, according to some aspects, in a method of replacing data in a cache memory including a plurality of cache sets including a plurality of ways, input data including an address of target data is received. The target data is data to be newly stored in the cache memory. For a target cache set of the target data among the plurality of cache sets, a set competition priority value is determined based on a set-access-count-since-last-miss (SALM) counter value representing a number of consecutive occurrences of a cache hit. For each of target ways included in the target cache set among the plurality of ways, a cache line recency priority value is determined based on a preuse distance value representing a difference between a first cache access time point and a second cache access time point. For each of the target ways, a tag bit priority value is determined based on a first tag bit subset array (TBSA) representing a part of the address of the target data and a second TBSA representing a part of address of cache data stored in each of the target ways. For each of the target ways, a first reference value is calculated based on the set competition priority value, the cache line recency priority value, and the tag bit priority value. The first reference value is used for selecting one of the target ways. A tag-age-based policy is performed based on the first reference value. The tag-age-based policy represents an operation for replacing first cache data stored in a first way among the target ways with the target data.

In general, according to some aspects, a cache data replacement system includes a cache memory, a processor, a set logic, a recency logic, a tag logic, a priority calculator, and a replacement logic. The cache memory includes data array including a plurality of cache sets, and the plurality of cache sets include a plurality of ways. The processor is configured to provide target data and input data including an address of the target data. The target data is data to be newly stored in the cache memory. The set logic is configured to determine a set competition priority value for a target cache set of the target data among the plurality of cache sets based on a SALM counter value representing a number of consecutive occurrences of a cache hit. The recency logic is configured to determine a cache line recency priority value for each of target ways included in the target cache set among the plurality of ways based on a preuse distance value representing a difference between a first cache access time point and a second cache access time point. The tag logic is configured to determine a tag bit priority value for each of the target ways based on a first TBSA representing a part of the address of the target data and a second TBSA representing a part of address of cache data stored in each of the target ways. The priority calculator is configured to calculate a first reference value for each of the target ways based on the set competition priority value, the cache line recency priority value, and the tag bit priority value. The first reference value is used for selecting one of the target ways. The replacement logic is configured to perform a tag-age-based policy based on the first reference value. The tag-age-based policy represents an operation for replacing the first cache data stored in the first way among the target ways with the target data.

In general, according to some aspects, in a method of replacing data in a cache memory including a plurality of cache sets including a plurality of ways, input data including an address of target data is received. The target data is data to be newly stored in the cache memory. For a target cache set of the target data among the plurality of cache sets, a first comparison result is obtained by comparing a target SALM counter value and at least one threshold value. The SALM counter value is a number of consecutive occurrences of a cache hit. A set competition priority value is obtained based on the first comparison result. For each of target ways included in the target cache set among the plurality of ways, a global counter value is increased by one whenever each time of a plurality of cache accesses occurs. A first cache access time point is stored. The first cache access time point is the global counter value at a time point when the most recent first cache access occurs among the plurality of cache accesses. A preuse distance value representing the difference between a second cache access time point and the first cache access time point is stored. The second cache access time point corresponds to the global counter value at a time point when a second cache access occurs before the first cache access among the plurality of cache accesses. A cache line recency priority value is obtained based on the preuse distance value. For each of the target ways, a second comparison result is obtained by comparing a first TBSA representing a part of an address of the target data and a second TBSA representing a part of an address of cache data stored in each of the target ways. A tag bit priority value is obtained based on the comparison result. For each of the target ways, a first reference value is calculated based on the set competition priority value, the cache line recency priority value, and the tag bit priority value. The first reference value is used for selecting one of the target ways. A tag-age-based policy is performed based on the first reference value. The tag-age-based policy represents an operation for replacing first cache data stored in a first way among the target ways with the target data.

In the method of replacing data in cache memory and the cache data replacement system according to example implementations, the data in the cache memory may be replaced considering the preuse distance of newly incoming data, which was not considered in the existing cache memory data replacement method. In addition, the area of the hardware required to store the information for the cache memory data replacement policy may be reduced by using the tag information stored in the cache memory.

### BRIEF DESCRIPTION OF THE DRAWINGS

Illustrative, non-limiting example implementations will be more clearly understood from the following detailed description taken in conjunction with the accompanying drawings.

FIG. 1 is a flowchart illustrating an example of a method of replacing data in a cache memory.

FIGS. 2 and 3 are block diagrams illustrating an example of a cache data replacement system.

FIG. 4 is a block diagram illustrating an example of a cache memory included in a cache data replacement system of FIG. 2.

FIGS. 5 and 6 are flowcharts illustrating examples of determining a set competition priority value in a method of replacing data in a cache memory.

FIG. 7 is a flowchart illustrating an example of determining a cache line recency priority value in a method of replacing data in a cache memory.

FIG. 8 is a diagram for describing an example of an operation in FIG. 7.

FIG. 9 is a block diagram illustrating an example of a cache data replacement system.

FIG. 10 is flowchart illustrating an example of determining a tag bit priority value in a method of replacing data in a cache memory.

FIG. 11 is a diagram for describing an example of an operation in FIG. 10.

FIG. 12 is a flowchart illustrating an example of a method of replacing data in a cache memory.

FIG. 13 is a flowchart illustrating an example of a method of replacing data in a cache memory.

FIG. 14 is a block diagram illustrating an example of a cache data replacement system.

FIG. 15 is a flowchart illustrating an example of a method of replacing data in a cache memory.

FIG. 16 is a block diagram illustrating an example of a cache data replacement system.

FIG. 17 is a flowchart illustrating an example of a method of replacing data in a cache memory.

FIG. 18 is a flowchart illustrating an example of a method of replacing data in a cache memory.

FIG. 19 is a flowchart illustrating an example of a method of replacing data in a cache memory.

FIG. 20 is a diagram for describing an example of a method of replacing data in a cache memory.

### DETAILED DESCRIPTION

Various example implementations will be described more fully with reference to the accompanying drawings, in which implementations are shown. The present disclosure may, however, be embodied in many different forms and should not be construed as limited to the implementations set forth herein. Like reference numerals refer to like elements throughout this application.

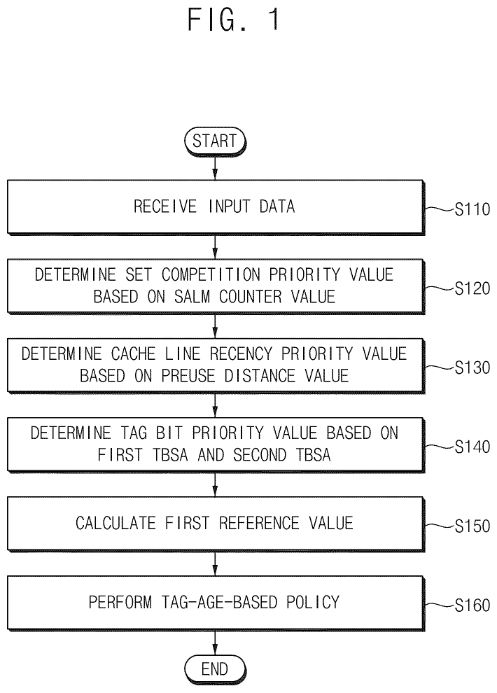

FIG. 1 is a flowchart illustrating an example of a method of replacing data in a cache memory.

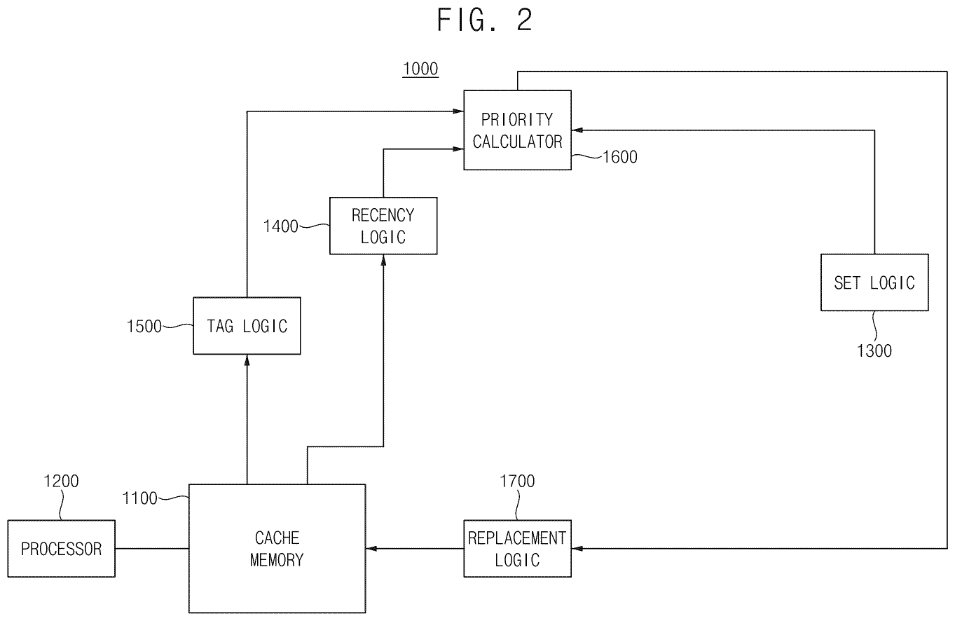

Referring to FIG. 1, a method of replacing data in a cache memory is performed by a cache data replacement system including a cache memory, a processor, a set logic, a recency logic, a tag logic, a priority calculator, and a replacement logic. The cache memory includes a data array including a plurality of cache sets, and the plurality of cache sets include a plurality of ways. The plurality of cache sets and the plurality of ways represent units of space for storing data in the cache memory. A configuration of the cache data replacement system will be described with reference to FIG. 2 and the like.

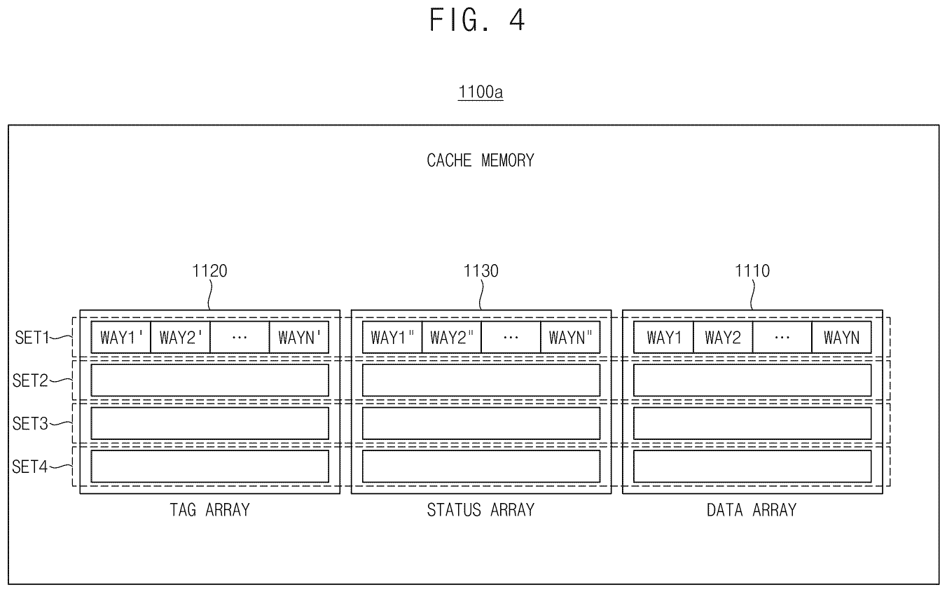

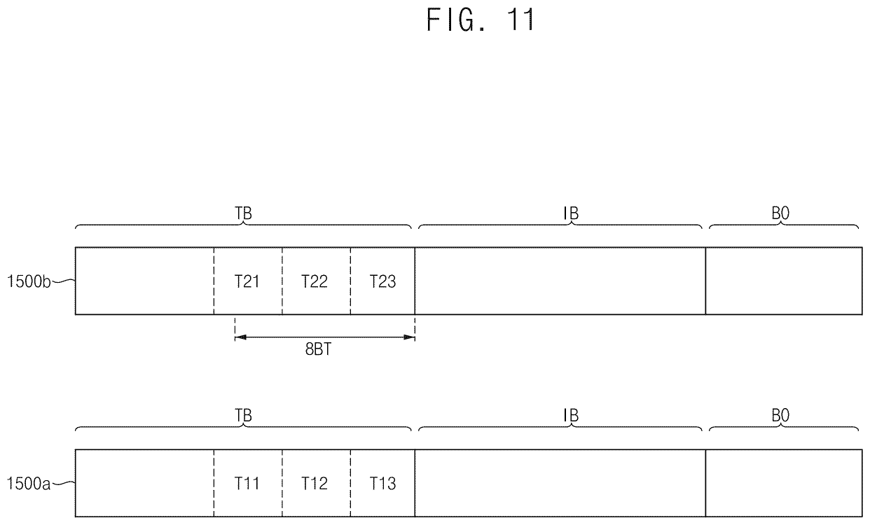

In the method of replacing data in the cache memory, input data including an address of target data is received (operation S100). The target data is data to be newly stored in the cache memory. For example, the address of the target data may be necessary to extract a tag bit subset array (TBSA) and an eight-bit tag, which will be described later. For example, the input data may further include an access type of data, and flag information representing whether a current phase is in a warm-up phase or not. For example, the access type of data may be necessary to determine whether the access type of data is a writeback type or a prefetch type. For example, the warm-up phase may represent or indicate a phase in which all policies are performed before a specific policy is selected. An example of the TBSA will be described with reference to FIG. 11, and a configuration of the cache memory will be described with reference to FIG. 4.

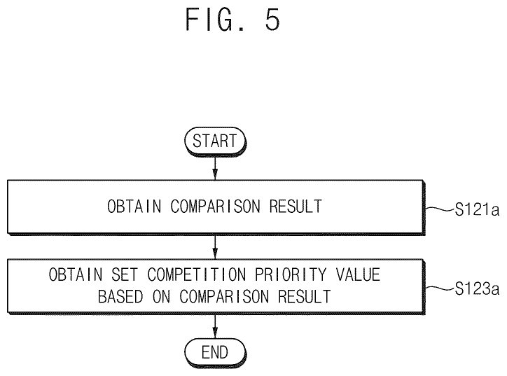

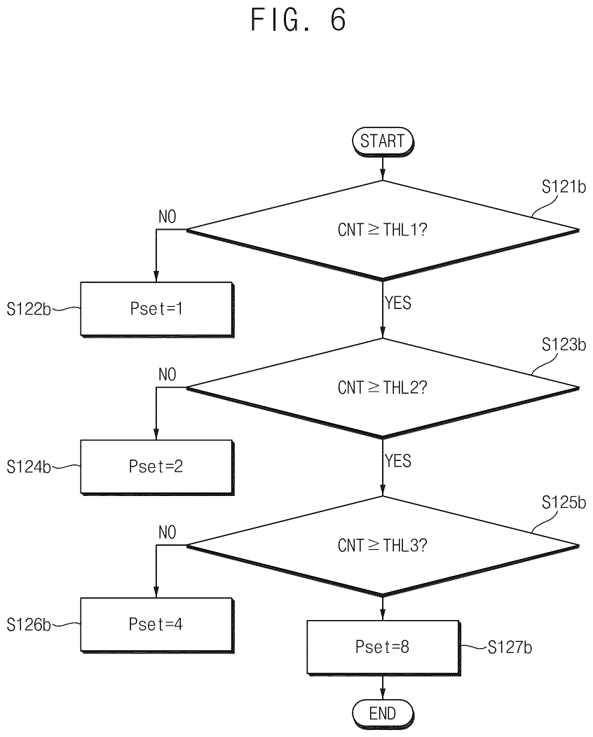

For a target cache set of the target data among the plurality of cache sets, a set competition priority value is determined based on a set-access-count-since-last-miss (SALM) (SALM) counter value representing a number of consecutive occurrences of a cache hit (operation S120). When specific data is to be used by the processor, the processor may request confirmation whether the data exists in the cache memory. When the data requested by the processor is found in the cache memory, this is referred to as a cache hit. When the data requested by the processor is not found in the cache memory, this is referred to as a cache miss. Operation S120 will be described with reference to FIGS. 5 and 6.

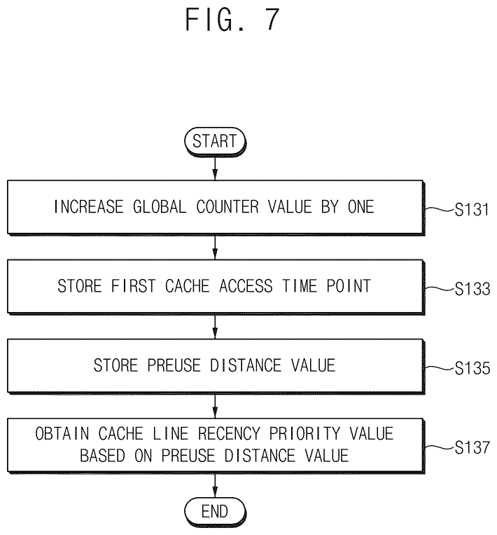

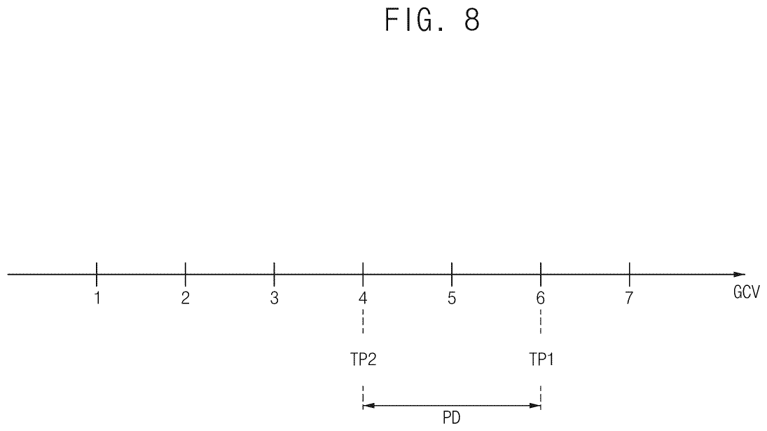

For each of target ways included in the target cache set among the plurality of ways, a cache line recency priority value is determined based on a preuse distance value representing a difference between a first cache access time point and a second cache access time point (operation S130). Operation S130 will be described with reference to FIGS. 7 and 8.

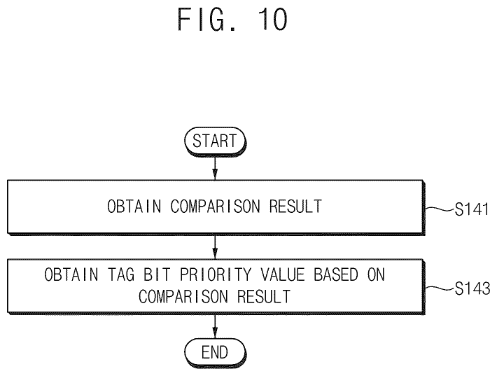

For each of the target ways, a tag bit priority value is determined based on a TBSA representing a part of the address of the target data and a second TBSA representing a part of address of cache data stored in each of the target ways. (operation S140). Operation S140 will be described with reference to FIG. 10, and the like.

For each of the target ways, a first reference value is calculated based on the set competition priority value, the cache line recency priority value, and the tag bit priority value. (operation S150). The first reference value is used for selecting one of the target ways. For example, the first reference value may be a value obtained by adding the tag bit priority value to a product of the set competition priority value and the cache line recency priority value.

A tag-age-based policy is performed based on the first reference value (operation S160). The tag-age-based policy represents an operation for replacing first cache data stored in a first way among the target ways with the target data. For example, when the first way among the target ways has the largest first reference value, the first cache data stored in the first way among the target ways may be replaced with the target data.

The cache memory may store a part of data stored in the main memory, and the data stored in the cache may be accessed faster than the data stored in the main memory. The bottlenecks caused by the speed difference between the processor with high speed and the main memory with low speed may be reduced by the cache memory. Among schemes for replacing data in cache memory, Belady's algorithm is widely known as a theoretically optimal data replacement policy. Accordingly, conventional cache data replacement policies assume the Belady's algorithm as the theoretical performance upper limit, and research on cache data replacement policies based on preuse distance prediction has been conducted to imitate the Belady's algorithm. In addition, with the development of machine learning, a reinforcement learning technique that learns optimal behavior through interaction with a given environment has been applied to cache data replacement policies. Therefore, a study that shows satisfactory performance with less hardware overhead than existing studies has appeared.

However, the existing cache data replacement policies based on preuse distance prediction do not consider the preuse distance of newly incoming data, so there is a problem that always the existing data is replaced even when data with a preuse distance greater than all data stored in the cache set is incoming. Accordingly, cache contamination may not be prevented, which means that data stored in the cache is discarded without being reused even once before being replaced with other data.

In the method of replacing data in cache memory and the cache data replacement system, the data in the cache memory may be replaced considering the preuse distance of newly incoming data, which was not considered in the existing cache memory data replacement method. In addition, the area of the hardware required to store the information for the cache memory data replacement policy may be reduced by using the tag information stored in the cache memory.

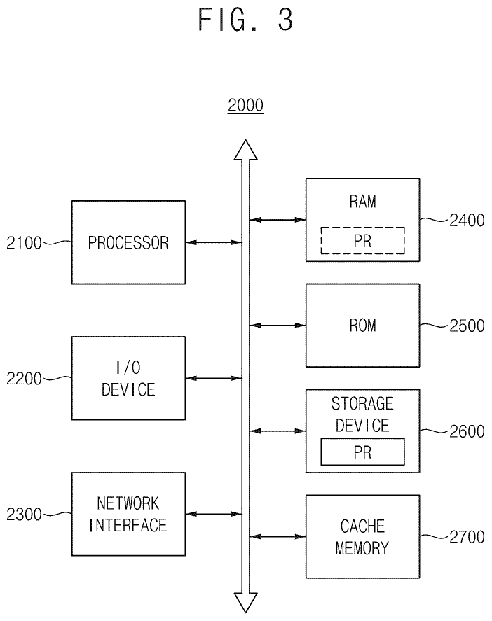

FIGS. 2 and 3 are block diagrams illustrating an example of a cache data replacement system.

Referring to FIG. 2, a cache data replacement system 1000 includes a cache memory 1100, a processor 1200, a set logic 1300, a recency logic 1400, a tag logic 1500, a priority calculator 1600, and a replacement logic 1700.

The cache memory 1100 includes a data array including a plurality of cache sets including a plurality of ways. The cache memory 1100 is a high-speed memory located between the processor and the main memory, and operates at a speed corresponding to the processor. The cache memory 1100 may store a part of the data stored in the main memory. The data stored in the cache memory 1100 may be accessed faster than the data stored in the main memory. The bottlenecks caused by the speed difference between the processor 1200 with high speed and the main memory with low speed may be reduced by the cache memory 1100.

The term ‘cache’ means a storage or preservation. The cache memory 1100 refers to a physical device or memory performing the storage or preservation. For example, the cache memory 1100 may be located between the processor 1200 and the main memory. For example, the cache memory 1100 may be located within the processor 1200 or located outside the processor 1200 depending on the role or performance of the cache memory 1100. The cache memory 1100 may have a function of an intermediate buffer that overcomes the difference between the relatively high processing speed of the processor 1200 and the relatively low operating speed of the main memory.

The processor 1200 provides target data and input data including an address of the target data. The target data is data to be newly stored in the cache memory 1100. The processor 1200 may control the operation of the cache data replacement system 1000 and may be used for the cache data replacement system 1000 to perform calculations. For example, the processor 1200 may include a microprocessor, an application processor (AP), a central processing unit (CPU), a digital signal processor (DSP), a graphic processing unit (GPU), a neural processing unit (NPU), and the like. Although FIG. 2 illustrates only one processor 1200, example implementations are not limited thereto, and the cache data replacement system 1000 may include a plurality of processors.

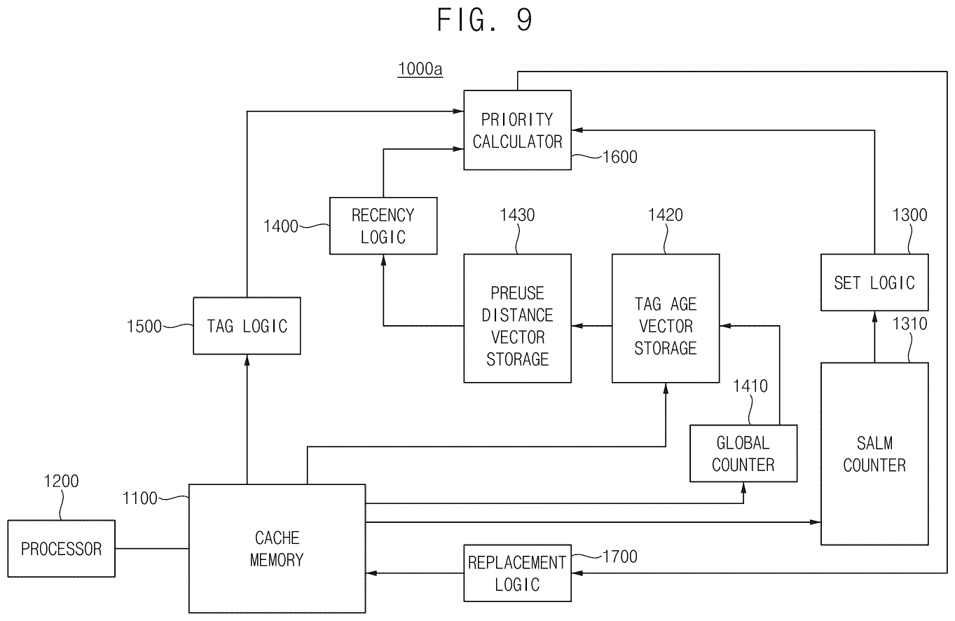

The set logic 1300 determines a set competition priority value for a target cache set of the target data among the plurality of cache sets based on a SALM counter value representing a number of consecutive occurrences of a cache hit. In other words, the set logic 1300 may perform operation S120 in FIG. 1. The operation of the set logic 1300 will be described with reference to FIG. 9, and the like.

The recency logic 1400 determines a cache line recency priority value for each of target ways included in the target cache set among the plurality of ways based on a preuse distance value representing a difference between a first cache access time point and a second cache access time point. In other words, the recency logic 1400 may perform operation S130 in FIG. 1. The operation of the recency logic 1400 will be described with reference to FIG. 9.

The tag logic 1500 determines a tag bit priority value for each of the target ways based on a first TBSA representing a part of the address of the target data and a second TBSA representing a part of address of cache data stored in each of the target ways. In other words, the tag logic 1500 may perform operation S140 in FIG. 1. The operation of the tag logic 1500 will be described with reference to FIGS. 10 and 11.

The priority calculator 1600 calculates a first reference value for each of the target ways based on the set competition priority value, the cache line recency priority value, and the tag bit priority value. The first reference value is used for selecting one of the target ways. For example, the first reference value may be a value obtained by adding the tag bit priority value to a product of the set competition priority value and the cache line recency priority value. In other words, the priority calculator 1600 may perform operation S150 in FIG. 1.

The replacement logic 1700 performs a tag-age-based policy based on the first reference value. The tag-age-based policy represents an operation for replacing the first cache data stored in the first way among the target ways with the target data. For example, when the first way among the target ways has the largest first reference value, the replacement logic 1700 may replace the first cache data stored in the first way among the target ways with the target data. In other words, the replacement logic 1700 may perform the operation S160 in FIG. 1.

Referring to FIG. 3, a cache data replacement system 2000 includes a processor 2100, an input/output (I/O) device 2200, a network interface 2300, a random access memory (RAM) 2400, a read only memory (ROM) 2500, a storage device 2600, and a cache memory 2700. FIG. 3 illustrates an example where all of the set logic 1300, the recency logic 1400, the tag logic 1500, the priority calculator 1600, and the replacement logic 1700 in FIG. 2 are implemented in software.

The cache data replacement system 2000 may be a computing system. For example, the computing system may be a fixed computing system such as a desktop computer, a workstation or a server, or may be a portable computing system such as a laptop computer.

The processor 2100 may be substantially the same as the processor 1200 in FIG. 2. For example, the processor 2100 may include a core or a processor core for executing an arbitrary instruction set (for example, intel architecture-32 (IA-32), 64 bit extension IA-32, x86-64, PowerPC, Sparc, MIPS, ARM, IA-64, etc.). For example, the processor 2100 may access a memory (e.g., the RAM 2400 or the ROM 2500) through a bus, and may execute instructions stored in the RAM 2400 or the ROM 2500. As illustrated in FIG. 3, the RAM 2400 may store a program PR corresponding to the set logic 1300, the recency logic 1400, the tag logic 1500, the priority calculator 1600, and the replacement logic 1700 in FIG. 2 or at least some elements of the program PR, and the program PR may allow the processor 2100 to perform the method of replacing data in the cache memory (e.g., operations S110, S120, S130, S140, S150, and S160 in FIG. 1).

In other words, the program PR may include a plurality of instructions and/or procedures executable by the processor 2100, and the plurality of instructions and/or procedures included in the program PR may allow the processor 2100 to perform the operations for replacing data in the cache memory. Each of the procedures may denote a series of instructions for performing a certain task. A procedure may be referred to as a function, a routine, a subroutine, or a subprogram. Each of the procedures may process data provided from the outside and/or data generated by another procedure.

The storage device 2600 may store the program PR. The program PR or at least some elements of the program PR may be loaded from the storage device 2600 to the RAM 2400 before being executed by the processor 2100. The storage device 2600 may store a file written in a program language, and the program PR generated by a compiler or the like or at least some elements of the program PR may be loaded to the RAM 2400.

The storage device 2600 may store data, which is to be processed by the processor 2100, or data obtained through processing by the processor 2100. The processor 2100 may process the data stored in the storage device 2600 to generate new data, based on the program PR and may store the generated data in the storage device 2600.

The I/O device 2200 may include an input device, such as a keyboard, a pointing device, or the like, and may include an output device such as a display device, a printer, or the like. For example, a user may trigger, through the I/O device 2200, execution of the program PR by the processor 2100, and may provide or check various inputs, outputs and/or data, etc.

The network interface 2300 may provide access to a network outside the cache data replacement system 2000. For example, the network may include a plurality of computing systems and communication links, and the communication links may include wired links, optical links, wireless links, or arbitrary other type links. Various inputs may be provided the cache data replacement system 2000 through the network interface 2300, and various outputs may be provided to another computing system through the network interface 2300.

In some example implementations, the computer program codes, the set logic 1300, the recency logic 1400, the tag logic 1500, the priority calculator 1600, and the replacement logic 1700 in FIG. 2 may be stored in a transitory or non-transitory computer readable medium. In some example implementations, values obtained from arithmetic processing performed by the processor may be stored in a transitory or non-transitory computer readable medium. In some example implementations, intermediate values generated during the calculating operation may be stored in a transitory or non-transitory computer readable medium. In some example implementations, various data may be stored in a transitory or non-transitory computer readable medium. However, example implementations are not limited thereto.

FIG. 4 is a block diagram illustrating an example of a cache memory included in a cache data replacement system of FIG. 2.

Referring to FIG. 4, a cache memory 1100a may include a data array 1110, a tag array 1120, and a status array 1130.

The data array 1110 may include at least a part of a plurality of cache sets. For example, the data array 1110 may include a first part of a first cache set SET1, a first part of a second cache set SET2, a first part of a third cache set SET3, and a first part of a fourth cache set SET4.

Each of the cache sets may include a plurality of ways. For example, the first cache set SET1 may include a total of N ways, including a first way WAY1, a second way WAY2,. an Nth way WAYN, where N is a positive integer. Similarly, the second cache set SET2, the third cache set SET3, and the fourth cache set SET4 may also include a total of N ways, respectively. Each of the ways WAY1, WAY2, . . . , WAYN in the data array 1110 may store cache data. Each of the ways WAY1, WAY2, . . . , WAYN in the data array 1110 may be referred to as a data way.

The tag array 1120 may include at least a part of the plurality of cache sets. For example, the tag array 1120 may include a second part of the first cache set SET1, a second part of the second cache set SET2, a second part of the third cache set SET3, and a second part of the fourth cache set SET4. Each of the cache sets may include the plurality of ways. For example, the first cache set SET1 may include a total of N ways, including a first way WAY1′, a second way WAY2′, . . . , and an Nth way WAYN′. Similarly, the second cache set SET2, the third cache set SET3, and the fourth cache set SET4 may also include a total of N ways, respectively. Each of the ways WAY1′, WAY2′, . . . , WAYN′ in the tag array 1120 may store tag bit information, which is a part of the address of cache data stored in each of the ways WAY1, WAY2, . . . , WAYN in the data array 1110. For example, the first way WAY1′ in the first cache set SET1 in the tag array 1120 may store tag bit information, which is a part of the address of cache data stored in the first way WAY1 in the first cache set SET1 in the data array 1110. The tag bit information may be used to extract TBSAs and eight-bit tags. The TBSAs and the eight-bit tags will be described with reference to FIG. 11. Each of the ways WAY1′, WAY2′, . . . , WAYN′ in the tag array 1120 may be referred to as a tag way.

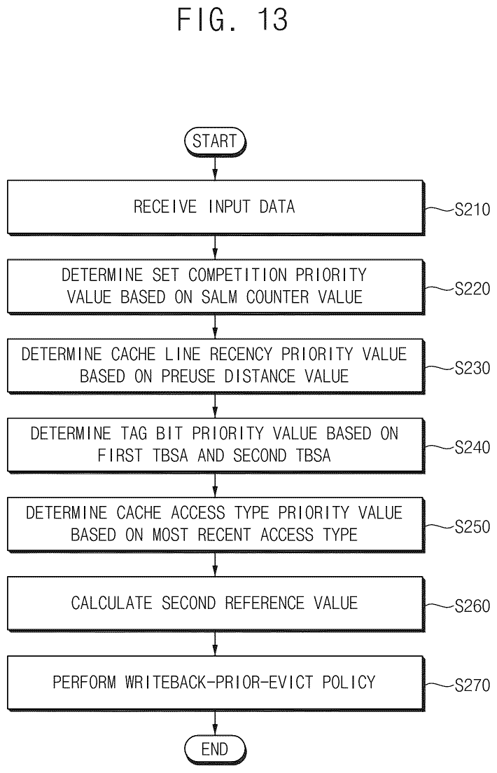

The status array 1130 may include at least a part of the plurality of cache sets. For example, the status array 1130 may include a third part of the first cache set SET1, a third part of the second cache set SET2, a third part of the third cache set SET3, and a third part of the fourth cache set SET4. Each of the cache sets may include the plurality of ways. For example, the first cache set SET1 may include a total of N ways, including a first way WAY1″, a second way WAY2″, . . . , an Nth way WAYN″. Similarly, the second cache set SET2, the third cache set SET3, and the fourth cache set SET4 may also each include a total of N ways. Each of the ways WAY1″, WAY2″, . . . , WAYN″ in the status array 1130 may store information regarding the most recent access type of cache data stored in each of the ways WAY1, WAY2, . . . , WAYN in the data array 1110. For example, the first way WAY1″ in the first cache set SET1 in the status array 1130 may store the information regarding the most recent access type of cache data stored in the first way WAY1 in the first cache set SET1 in the data array 1110. The information regarding the most recent access type will be described with reference to FIG. 13. Each of the ways WAY1″, WAY2″, . . . , WAYN″ in the status array 1130 may be referred to as a status way.

Although FIG. 4 illustrates an example where the number of cache sets is four, example implementations are not limited thereto, and the number of cache sets may be less than four or more than four.

FIGS. 5 and 6 are flowcharts illustrating examples of determining a set competition priority value in a method of replacing data in a cache memory.

Referring to FIG. 5, when determining the set competition priority value (operation S120), a comparison result may be obtained by comparing a target SALM counter value for the target cache set and at least one threshold value (operation S121a). The target cache set may be determined depending on the address of the target data to be newly stored in the cache memory. For example, the first cache set SET1 in FIG. 4 may be the target cache set.

The set competition priority value may be obtained based on the comparison result (operation S123a).

Referring to FIG. 6, when determining the set competition priority value (operation S120), it may be determined whether a SALM counter value CNT is greater than or equal to a first threshold value THL1 (operation S121b).

If the SALM counter value CNT is less than the first threshold value THL1 (operation S121b: NO), a set competition priority value Pset may be determined to one (operation S122b). For example, the first threshold value THL1 may be sixteen.

If the SALM counter value CNT is greater than or equal to the first threshold value THL1 (operation S121b: YES), it may be determined whether the SALM counter value CNT is greater than or equal to a second threshold value THL2 (operation S123b).

If the SALM counter value CNT is less than the second threshold value THL2 (operation S123b: NO), the set competition priority value Pset may be determined to two (operation S124b). For example, the second threshold value THL2 may be thirty-two.

If the SALM counter value CNT is greater than or equal to the second threshold value THL2 (operation S123b: YES), it may be determined whether the SALM counter value CNT is greater than or equal to a third threshold value THL3 (operation S125b).

If the SALM counter value CNT is less than the third threshold value THL3 (operation S125b: NO), the set competition priority value Pset may be determined to four (operation S126b). For example, the third threshold value THL3 may be sixty-four.

If the SALM counter value CNT is greater than or equal to the third threshold value THL3 (operation S125b: YES), the set competition priority value Pset may be determined to eight (operation S127b).

For example, operations S121b, S123b, and S125b may be included in operation S121a in FIG. 5, and operations S122b, S124b, S126b, and S127b may be included in operation S123a in FIG. 5.

Although FIG. 6 illustrates a case where the number of the threshold values are three and the set competition priority value Pset is one, two, four, or eight, example implementations are not limited thereto, and the number of the threshold values may be less than three or more than three, and the set competition priority value Pset may be variously determined.

FIG. 7 is a flowchart illustrating an example of determining a cache line recency priority value in a method of replacing data in a cache memory. FIG. 8 is a diagram for describing an example of an operation in FIG. 7.

Referring to FIGS. 4, 7, and 8, when determining the cache line recency priority value (operation S130), a global counter value may be increased by one whenever each of a plurality of cache accesses occurs (operation S131). The cache access means an operation of checking whether the data requested by the processor exists in the cache memory. When the data requested by the processor is found in the cache memory, this is referred to as a cache hit. When the data requested by the processor is not found in the cache memory, this is referred to as a cache miss. The cache access may be a concept that includes both the cache hit and the cache miss. For example, when the cache hit occurs, the global counter value may be increased by one. For example, when the cache miss occurs, the global counter value may be increased by one.

The first cache access time point corresponding to the global counter value at a time point when a first cache access occurs may be stored (operation S133). The first cache access may be the most-recently occurring cache access among the plurality of cache accesses.

The preuse distance value representing the difference between the second cache access time point and the first cache access time point may be stored (operation S135). The second cache access time point may correspond to the global counter value at a time point when a second cache access occurs before the first cache access among the plurality of cache accesses The cache line recency priority value may be obtained based on the preuse distance value (operation S137).

Operations S133, S135, and S137 will be described with reference to FIG. 8, and the like.

In FIG. 8, a horizontal axis may represent a global counter value GCV. The global counter value GCV may be increased by one whenever each of the plurality of cache accesses occurs (operation S130 in FIG. 7). For example, the global counter value GCV may be increased by one whenever each of the plurality of cache accesses occurs and may have values of one, two, three, four, five, six, and seven.

As illustrated in FIG. 4, the plurality of cache sets SET1, SET2, SET3, and SET4 may include the plurality of ways WAY1, WAY2, . . . , WAYN, respectively. Among the plurality of ways WAY1, WAY2, . . . , WAYN, for each of the target ways (e.g., WAY1, WAY2, . . . , WAYN in FIG. 4) included in the target cache set (e.g., SET1 in FIG. 4) of the target data to be newly stored in the cache memory, the first cache access time and the second cache access time may be determined, and the preuse distance value representing the difference between the first cache access time and the second cache access time may be determined.

For example, FIG. 8 illustrates an operation of determining the first cache access time, the second cache access time, and the preuse distance value for one target way (e.g., WAY1 in FIG. 4), among the target ways (e.g., WAY1, WAY2, . . . , WAYN in FIG. 4).

For example, if a cache access occurs in the second way WAY2 included in the target cache set SET1, the global counter value GCV may be increased to one. For example, if a cache access occurs in the third way WAY3 included in the target cache set SET1, the global counter value GCV may be increased to two. For example, if a cache access occurs in the second way WAY2 included in the target cache set SET1, the global counter value GCV may be increased to three. For example, if a cache access occurs in the first way WAY1 included in the target cache set SET1, the global counter value GCV may be increased to four. For example, if a cache access occurs in the second way WAY2 included in the target cache set SET1, the global counter value GCV may be increased to five. For example, if a cache access occurs in the first way WAY1 included in the target cache set SET1, the global counter value GCV may be increased to six. For example, if a cache access occurs in the fourth way WAY4 included in the target cache set SET1, the global counter value GCV may be increased to seven.

For example, if the target way is the first way WAY1, the global counter value GCV may be stored whenever each of the plurality of cache accesses occurs in the target way WAY1. A first cache access time point TP1 may correspond to the global counter value GCV at a time point when a first cache access occurs. The first cache access is the most-recently occurring cache access among the plurality of cache accesses. A second cache access time point TP2 may corresponds to the global counter value GCV at a time point when a second cache access occurs before the first cache access among the plurality of cache accesses. For example, the difference between the first cache access time TP1 and the second cache access time TP2 may be a peruse distance value PD. For example, if the first cache access time TP1 of the target way WAY1 is six and the second cache access time TP2 is four, the preuse distance value PD of the target way WAY1 may be two.

In FIG. 8, example implementations are described based on the case where the first cache access time point TP1, the second cache access time point TP2, and the preuse distance value PD are applied only for the target way WAY1, and the first cache access time point TP1 is six, the second cache access time point TP2 is four, and the preuse distance value PD is two. However, example implementations are not limited thereto, and example implementations may be applied to the each of the plurality of ways WAY1, WAY2, . . . , WAYN included in the plurality of cache sets SET1, SET2, SET3, and SET4, and the first cache access time point TP1, the second cache access time point TP2, and the preuse distance value PD may also have various values.

FIG. 9 is a block diagram illustrating an example of a cache data replacement system.

Referring to FIG. 9, a cache data replacement system 1000a may include a cache memory 1100, a processor 1200, a set logic 1300, a recency logic 1400, a tag logic 1500, a priority calculator 1600, a replacement logic 1700, a SALM counter 1310, a global counter 1410, a tag age vector storage 1420, and a preuse distance vector storage 1430. In the cache data replacement system 1000a, the cache memory 1100, the processor 1200, the set logic 1300, the recency logic 1400, the tag logic 1500, the priority calculator 1600, and the replacement logic 1700 may be substantially the same as the cache memory 1100, the processor 1200, the set logic 1300, the recency logic 1400, the tag logic 1500, the priority calculator 1600, and the replacement logic 1700 in FIG. 2, respectively. Hereinafter, the descriptions repeated with or overlapping with descriptions of FIG. 2 will be omitted in the interest of brevity.

The SALM counter 1310 may store the SALM counter value representing the number of consecutive occurrences of cache hits for the target cache set (e.g., SET1 in FIG. 4) of the target data among the plurality of cache sets. Whenever the cache hit occurs in which data requested by the processor is found in the cache memory, the SALM counter value of the target cache set SET1 in FIG. 4 increases by one, and the SALM counter value may be stored in the SALM counter 1310. The SALM counter 1310 may store different SALM counter values for each cache sets. For example, as illustrated in FIG. 4, when the plurality of cache sets include the first cache set SET1, the second cache set SET2, the third cache set SET3, and the fourth cache set SET4, the SALM counter value of the first cache set SET1, the SALM counter value of the second cache set SET2, the SALM counter value of the third cache set SET3, and the SALM counter value of the fourth cache set SET4 may be stored in the SALM counter 1310, respectively. In other words, the SALM counter 1310 may perform operation S120 in FIG. 1.

The set logic 1300 may determine the set competition priority value based on the SALM counter value determined by the SALM counter 1310 and the threshold value of the target cache set.

For example, as illustrated in FIG. 6, if the SALM counter value CNT of the target cache set determined by the SALM counter 1310 is not greater than or equal to the first threshold value THL1 (operation S121b: NO), the set logic 1300 may determine that the set competition priority value Pset is one (operation S122b). If the SALM counter value CNT of the target cache set determined by the SALM counter 1310 is not greater than or equal to the second threshold value THL2 (operation S123b: NO), the set logic 1300 may determine that the set competition priority value Pset is two (operation S124b). If the SALM counter value CNT of the target cache set determined by the SALM counter 1310 is not greater than or equal to the third threshold value THL3 (operation S125b: NO), the set logic 1300 may determine that the set contention priority value Pset is four (operation S126b). If the SALM counter value CNT of the target cache set determined by the SALM counter 1310 is greater than or equal to the third threshold value THL3 (operation S125b: YES), the set logic 1300 may determine that the set contention priority value Pset is eight (operation S127b). In other words, the set logic 1300 may perform operation S120 in FIG. 1, operations S121b, S122b, S123b, S124b, S125b, S126b, and S127b in FIG. 6.

Although FIGS. 6 and 9 illustrate the case where the number of the threshold values is three and the set competition priority value Pset determined by the set logic 1300 is 1, 2, 4, or 8, example implementations are not limited thereto, and the number of the threshold values may be less than or more than three, and the set competition priority value Pset determined by the set logic 1300 may also have various values.

The global counter 1410 may store the global counter value that increases by one whenever each of a plurality of cache accesses occurs. The cache access is a concept that includes both the cache hit and the cache miss. For example, when the cache hit occurs, the global counter value may be increased by one. For example, when the cache miss occurs, the global counter value may be increased by one. For example, the global counter value may be stored in the global counter 1410. In other words, the global counter 1410 may perform operation S131 in FIG. 7.

The tag age vector storage 1420 may store the first cache access time point, corresponding to the global counter value at a time point when a first cache access occurs. The first cache access may be a most-recently occurring cache access among the plurality of cache accesses. For example, the tag age vector storage 1420 may extract an eight-bit tag (e.g., 8BT in FIG. 11), which is a part of the tag bits stored in the tag array (e.g., 1120 in FIG. 4) included in the cache memory. The eight-bit tag will be described with reference to FIG. 11.

The eight-bit tag may have a total of 256 values from ‘00000000’ to ‘11111111’. For example, the tag age vector storage 1420 may have rows according to all cases of the eight-bit tag, and the rows may be sorted according to the ascending order of the eight-bit tag. Therefore, a total of 256 rows may exist in the tag age vector storage 1420.

For example, FIGS. 4 and 8 illustrate an operation of determining the first cache access time, the second cache access time, and the preuse distance value for one target way WAY1 among the target ways WAY1, WAY2, . . . , WAYN. The global counter value GCV whenever each of a plurality of cache accesses occurs in the target way WAY1 may be stored in the global counter 1410. The second cache access time TP2, corresponding to the global counter value GCV at a time point when the most-recently occurring cache access among the plurality of cache accesses before the first cache access time TP1, may be stored in the tag age vector storage 1420. In this case, the second cache access time TP2 may be stored in a row of the tag age vector storage 1420 corresponding to the eight-bit tag, which is a part of the address of the cache data stored in the target way WAY1.

For example, if the eight-bit tag of the cache data stored in the target way WAY1 is ‘00000000’, the second cache access time TP2 of the target way WAY1 may be stored in the first row of the tag age vector storage 1420. For example, if the eight-bit tag of the cache data stored in the target way WAY1 is ‘00000010’, the second cache access time TP2 of the target way WAY1 may be stored in the third row of the tag age vector storage 1420. For example, if the eight-bit tag of the cache data stored in the target way WAY1 is ‘11111111’, the second cache access time TP2 of the target way WAY1 may be stored in the 256th row of the tag age vector storage 1420.

For example, if the first cache access occurs after the second cache access, the second cache access time point TP2 stored in the tag age vector storage 1420 may be replaced by the first cache access time point TP1. For example, the first cache access time point TP1, corresponding to the global counter value GCV at a time point when the earliest occurring cache access among the plurality of cache accesses after the second cache access time TP2, may replace the second cache access time point TP2 stored in the tag age vector storage 1420.

For example, if the eight-bit tag of the cache data stored in the target way WAY1 is ‘00000000’, the first cache access time point TP1 of the target way WAY1 may replace the second cache access time point TP2 stored in the first row of the tag age vector storage 1420. For example, if the eight-bit tag of the cache data stored in the target way WAY1 is ‘00000010’, the first cache access point TP1 of the target way WAY1 may replace the second cache access point TP2 stored in the third row of the tag age vector storage 1420. For example, if the eight-bit tag of the cache data stored in the target way WAY1 is ‘11111111’, the first cache access point TP1 of the target way WAY1 may replace the second cache access point TP2 stored in the 256th row of the tag age vector storage 1420.

In other words, the tag age vector storage 1420 may perform operation S133 in FIG. 7.

The preuse distance vector storage 1430 may store the preuse distance value representing the difference between the second cache access time point and the first cache access time point. The second cache access time point may correspond to the global counter value at a time point when the second cache access occurs before the first cache access among the plurality of cache accesses. For example, when the first cache access time TP1 replaces the second cache access time TP2, the preuse distance value PD, which is the difference between the first cache access time TP1 and the second cache access time TP2, may be stored in the preuse distance vector storage 1430.

For example, the preuse distance vector storage 1430, similar to the tag age vector storage 1420, may have rows according to the number of all cases of the eight-bit tag, and the rows may be sorted according to the ascending order of the eight-bit tag. Therefore, the preuse distance vector storage 1430 may have a total of 256 rows.

For example, if the eight-bit tag of the cache data stored in the target way WAY1 is ‘00000000’, then when the first cache access time TP1 of the target way WAY1 replaces the second cache access time TP2 stored in the first row of the tag age vector storage 1420, the preuse distance value PD may be stored in the first row of the preuse distance vector storage 1430. For example, if the eight-bit tag of the cache data stored in the target way WAY1 is ‘00000010’, then when the first cache access time TP1 of the target way WAY1 replaces the second cache access time TP2 stored in the third row of the tag age vector storage 1420, the preuse distance value PD may be stored in the third row of the preuse distance vector storage 1430. For example, if the eight-bit tag of the cache data stored in the target way WAY1 is ‘11111111’, then when the first cache access time TP1 of the target way WAY1 replaces the second cache access time TP2 stored in the 256th row of the tag age vector storage 1420, the preuse distance value PD may be stored in the 256th row of the preuse distance vector storage 1430.

In other words, the preuse distance vector storage 1430 may perform operation S135 in FIG. 7.

The recency logic 1400 may obtain the cache line recency priority value for each of the target ways based on the preuse distance value representing the difference between the first cache access time and the second cache access time. The recency logic 1400 may assign priority to the preuse distance values PD stored in the preuse distance vector storage 1430. For example, if the number of ways included in the cache set is sixteen, the priority may be assigned by assigning sixteen to the largest value among the preuse distance values stored in the preuse distance vector storage 1430, fifteen to the next largest value, and fourteen to the next largest value.

For example, if the eight-bit tag of the cache data stored in the target way WAY1 is ‘00000000’ and the preuse distance value PD stored in the first row of the preuse distance vector storage 1430 is the largest value among the preuse distance values stored in the preuse distance vector storage 1430, the cache line recency priority value may be sixteen. For example, if the eight-bit tag of the cache data stored in the target way WAY1 is ‘00000010’ and the preuse distance value PD stored in the third row of the preuse distance vector storage 1430 is the third largest value among the preuse distance values stored in the preuse distance vector storage 1430, the cache line recency priority value may be fourteen. For example, if the eight-bit tag of the cache data stored in the target way WAY1 is ‘11111111’ and the preuse distance value PD stored in the 256th row of the preuse distance vector storage 1430 is the 19th largest value among the preuse distance values stored in the preuse distance vector storage 1430, the cache line recency priority value may be zero.

In other words, the recency logic 1400 may perform operation S137 in FIG. 7.

Although example implementations are described based on the eight-bit tag, which is a part of the tag bits stored in the tag array 1120 of FIG. 4 included in the cache memory, but example implementations are not limited thereto, and the seven-bit and nine-bit parts of the tag bits may be used.

Although example implementations are described based on the case where the rows are sorted in ascending order of the eight-bit tags in the tag age vector storage 1420 and the preuse distance vector storage 1430. However, example implementations are not limited thereto, and the rows may be sorted in descending order of the eight-bit tags.

For example, the global counter value GCV stored in the global counter 1410 in FIGS. 8 and 9 may be eighteen bits. For example, the first cache access time TP1 and the second cache access time TP2 stored in the tag age vector storage 1420, and the preuse distance value PD stored in the preuse distance vector storage 1430 may be sixteen bits obtained by dividing the eighteen-bits global counter value GCV by four (i.e., performing a right shift 2 times). However, example implementations are not limited thereto, and the global counter value GCV may be a value other than eighteen bits, and the first cache access time TP1, the second cache access time TP2, and the preuse distance value PD may be values other than sixteen bits.

FIG. 10 is flowchart illustrating an example of determining a tag bit priority value in a method of replacing data in a cache memory. FIG. 11 is a diagram for describing an example of an operation in FIG. 10.

Referring to FIGS. 10 and 11, when determining the tag bit priority value (operation S140), a comparison result may be obtained by comparing a first-first TBSA T11 and a first-second TBSA T12 included in the first TBSA and a second-first TBSA T21 and a second-second TBSA T22 included in the second TBSA, respectively (operation S141). For example, FIG. 11 illustrates an address of target data 1500a to be newly stored in the cache memory, and an address of cache data 1500b stored in each of the target ways included in the target cache set of the target data. For example, the address of the target data 1500a and the address of the cache data 1500b may be thirty-two bits. For example, the lower six bits of the address of the target data 1500a and the address of the cache data 1500b may be used as a byte offset BO, and the next lower eleven bits may be used as an index bit IB. For example, the remaining fifteen bits of the address of the target data 1500a and the address of the cache data 1500b, excluding the byte offset BO and the index bit IB, may be used as a tag bit TB. For example, the lower nine bits of the tag bit TB may be referred to as a TBSA. For example, among the TBSA, the upper three bits may be referred to as a first TBSA, the middle three bits may be referred to as a second TBSA, and the lower three bits may be referred to as a third TBSA. For example, among the lower nine bits excluding the byte offset BO and the index bit IB in the address of the target data 1500a, the upper three bits, the middle three bits, and the lower three bits may be referred to as the first-first TBSA T11, the first-second TBSA T12, and the first-third TBSA T13, respectively. For example, among the lower nine bits excluding the byte offset BO and the index bit IB in the address of the cache data 1500b, the upper three bits, the middle three bits, and the lower three bits may be referred to as the second-first TBSA T21, the second-second TBSA T22, and the second-third TBSA T23, respectively.

For example, the comparison result may be obtained by comparing the first-first TBSA T11 and the second-first TBSA T21, and by comparing the first-second TBSA T12 and the second-second TBSA T22.

The set competition priority value may be obtained based on the comparison result (operation S143). For example, if the first-first TBSA T11 and the second-first TBSA T21 are the same, and the first-second TBSA T12 and the second-second TBSA T22 are the same, the set competition priority value may be determined to 1024. For example, if the first-first TBSA T11 and the second-first TBSA T21 are different, or the first-second TBSA T12 and the second-second TBSA T22 are different, the set competition priority value may be zero.

For example, operations S141 and S143 may be performed by the tag logic 1500 in FIG. 2. The tag logic 1500 may obtain the comparison result by comparing the first-first TBSA T11 and the second-first TBSA T21, and the first-second TBSA T12 and the second-second TBSA T22, respectively. For example, if the first-first TBSA T11 and the second-first TBSA T21 are the same, and the first-second TBSA T12 and the second-second TBSA T22 are the same, the tag logic 1500 may determine the set competition priority value as 1024. For example, if the first-first TBSA T11 and the second-first TBSA T21 are different, or the first-second TBSA T12 and the second-second TBSA T22 are different, the tag logic 1500 may determine the set competition priority value as zero.

For example, the part of the lower eight bits in the address of the cache data 1500b, excluding the byte offset BO and the index bit IB, may be referred to as an eight-bit tag 8BT.

In FIG. 11, the description is limited to the case where the byte offset BO is 6 bits, the index bit IB is 11 bits, and the tag bit TB is 15 bits, but the present disclosure is not limited thereto, and the byte offset BO can have a value other than 6, the index bit IB can have a value other than 11 bits, and the tag bit TB may have a value other than 15 bits, respectively.

In FIG. 11, example implementations are described based on the case where the set competition priority value is 1024 or zero. However, example implementations are not limited thereto, and the set competition priority value may have a value other than 1024 or zero.

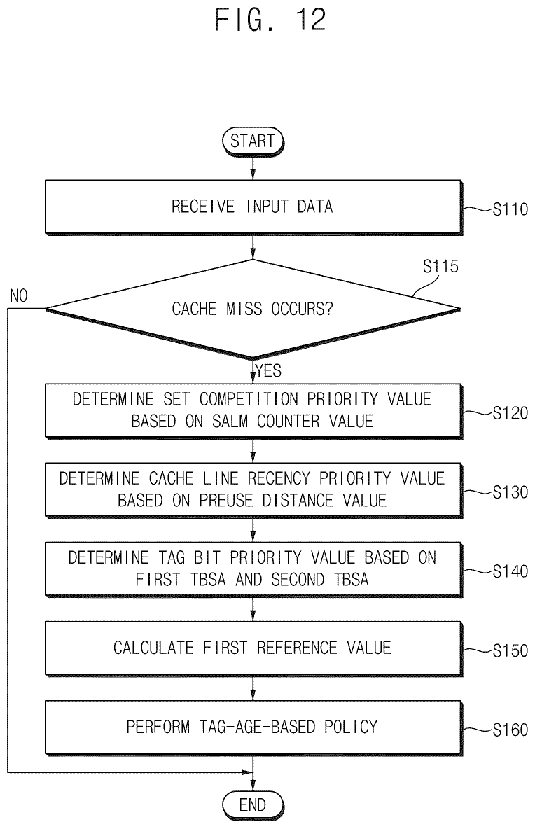

FIG. 12 is a flowchart illustrating an example of a method of replacing data in a cache memory.

Referring to FIG. 12, the method of replacing data in a cache memory may include operations S110, S115, S120, S130, S140, S150, and S160. For example, operation S115 may be performed after operation S110. Operation S110 to S160 may be substantially the same as operation S110 to S160 in FIG. 1, respectively. Hereinafter, the descriptions repeated with or overlapping with descriptions of FIG. 1 will be omitted in the interest of brevity.

It may be determined whether a cache miss occurs for the target data (operation S115). When the data requested by the processor is not found in the cache memory, this is referred to as a cache miss. If the cache miss has not occurred for the target data (operation S115: NO), there is no need to replace data in the cache memory, the operation of replacing data in a cache memory may be terminated. If the cache miss has occurred for the target data (operation S115: YES), operations S120 to S160 may be performed.

FIG. 13 is a flowchart illustrating an example of a method of replacing data in a cache memory.

Referring to FIG. 13, the method of replacing data in a cache memory may include operations S210, S220, S230, S240, S250, S260, and S270. Operations S210 to S240 may be substantially the same as operations S110 to S140 in FIG. 1, respectively. Hereinafter, the descriptions repeated with or overlapping with descriptions of FIG. 1 will be omitted in the interest of brevity.

For each of the target ways, a cache access type priority value may be determined based on the most recent access type of cache data stored in each of the target ways (operation S250). For example, the cache access type priority value of cache data whose most recent access type is writeback among cache data stored in each of the target ways may be two. For example, the cache access type priority value of cache data whose most recent access type is not writeback may be one. Writeback means an access type in which, when the first data is written to the cache memory, the first data is not updated to the main memory, but is only written to the cache memory, and when the first data is replaced with the second data, the first data is updated to the main memory.

In FIG. 13, example implementations are described based on the case where the cache access type priority value is two or one. However, example implementations are not limited thereto, and the cache access type priority value may have a value other than two or one.

For each of the target ways, a second reference value may be calculated based on the set competition priority value, the cache line recency priority value, the tag bit priority value, and the cache access type priority value (operation S260). The second reference value may be used for selecting one of the target ways. For example, the first reference value may be a value obtained by adding the tag bit priority value to the product of the set competition priority value and the cache line recency priority value, and the second reference value may be product of the first reference value and the cache access type priority value.

A writeback-prior-evict policy may be performed based on the second reference value (operation S270). The writeback-prior-evict policy may represent an operation for replacing second cache data stored in a second way among the target ways with the target data. For example, if the second way among the target ways has the largest second reference value, the second cache data stored in the second way among the target ways may be replaced with the target data.

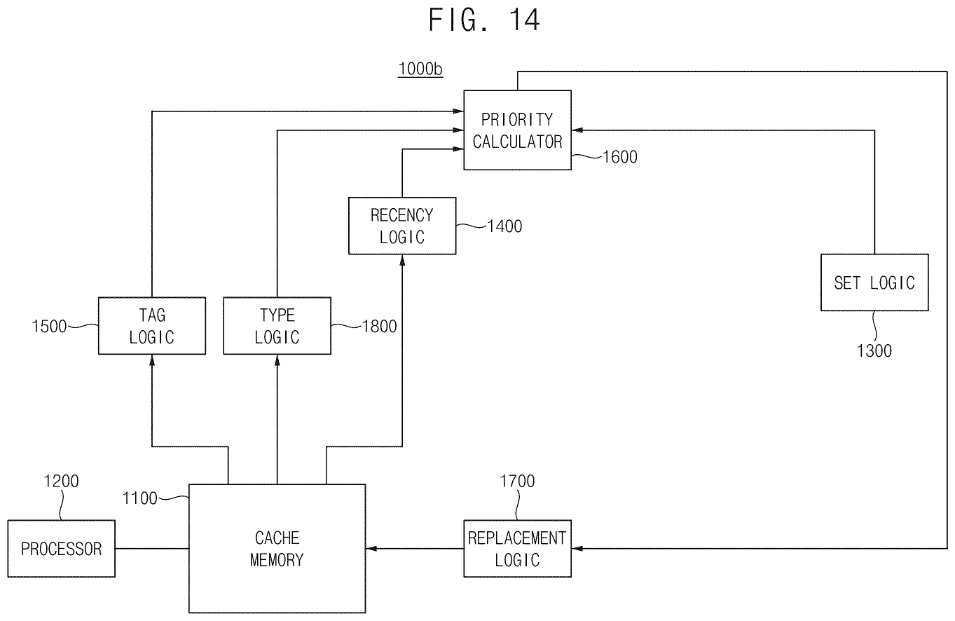

FIG. 14 is a block diagram illustrating an example of a cache data replacement system.

Referring to FIG. 14, a cache data replacement system 1000b may include a cache memory 1100, a processor 1200, a set logic 1300, a recency logic 1400, a tag logic 1500, a priority calculator 1600, a replacement logic 1700, and a type logic 1800. In the cache data replacement system 1000b, the cache memory 1100, the processor 1200, the set logic 1300, the recency logic 1400, the tag logic 1500, the priority calculator 1600, and the replacement logic 1700 may be substantially the same as the cache memory 1100, the processor 1200, the set logic 1300, the recency logic 1400, the tag logic 1500, the priority calculator 1600, and the replacement logic 1700 in FIG. 2, respectively. Hereinafter, the descriptions repeated with or overlapping with descriptions of FIG. 2 will be omitted in the interest of brevity.

The type logic 1800 may determine a cache access type priority value for each of the target ways based on the most recent access type stored in the status array (e.g., 1130 in FIG. 4). For example, the type logic 1800 may determine the cache access type priority value of cache data whose most recent access type is writeback among cache data stored in each of the target ways to be two, and may determine the cache access type priority value of cache data whose most recent access type is not writeback to be one. In other words, the type logic 1800 may perform operation S250 in FIG. 13.

The priority calculator 1600 may calculate a second reference value for each of the target ways based on the set competition priority value, the cache line recency priority value, the tag bit priority value, and the cache access type priority value. The second reference value may be used for selecting one of the target ways. For example, the first reference value may be a value obtained by adding the tag bit priority value to the product of the set competition priority value and the cache line recency priority value. For example, the first reference value may be a value obtained by adding the tag bit priority value to the product of the set competition priority value and the cache line recency priority value, and the second reference value may be a product of the first reference value and the cache access type priority value. In other words, the priority calculator 1600 may perform operation S260 in FIG. 13.

The replacement logic 1700 may perform a writeback-prior-evict policy based on the second reference value. The writeback-prior-evict policy may represent an operation for replacing second cache data stored in a second way among the target ways with the target data. For example, if the second way among the target ways has the largest second reference value, the replacement logic 1700 may replace the second cache data stored in the second way among the target ways with the target data. In other words, the replacement logic 1700 may perform operation S270 in FIG. 13.

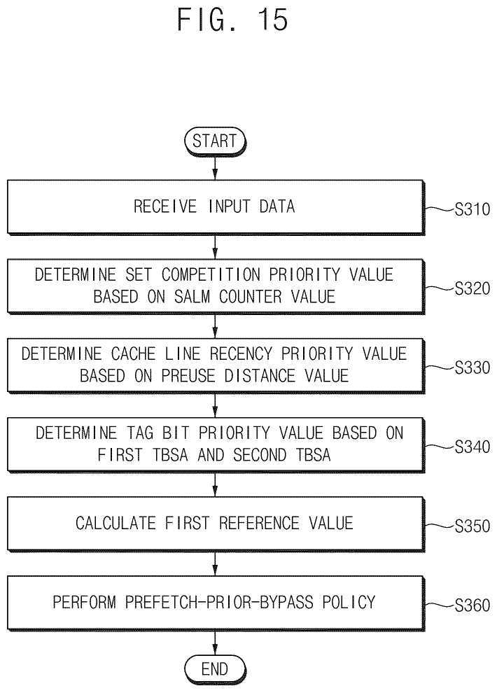

FIG. 15 is a flowchart illustrating an example of a method of replacing data in a cache memory.

Referring to FIG. 15, the method of replacing data in a cache memory may include operations S310, S320, S330, S340, S350, and S360. Operations S310 to S350 may be substantially the same as operations S110 to S150 in FIG. 1, respectively. Hereinafter, the descriptions repeated with or overlapping with descriptions of FIG. 1 will be omitted in the interest of brevity.

A prefetch-prior-bypass policy may be performed (operation S360). The prefetch-prior-bypass policy may represent an operation, in which, when an access type of the target data is the prefetch type, the target data is bypassed without being stored, and when the access type of the target data is not the prefetch type, third cache data stored in a third way among the target ways is replaced with the target data

The prefetch type means an access type that retrieves data in advance before the data is needed and stores the data in a cache memory so that the data may be used immediately when needed. Bypass means bypassing the target data without storing the target data in a cache memory.

For example, if the access type of target data to be newly stored in the cache memory is the prefetch type, the target data may be bypassed without being stored in the cache memory. For example, if the access type of target data to be newly stored in the cache memory is not the prefetch type, the third cache data stored in the third way may be replaced with the target data by the tag-age-based policy.

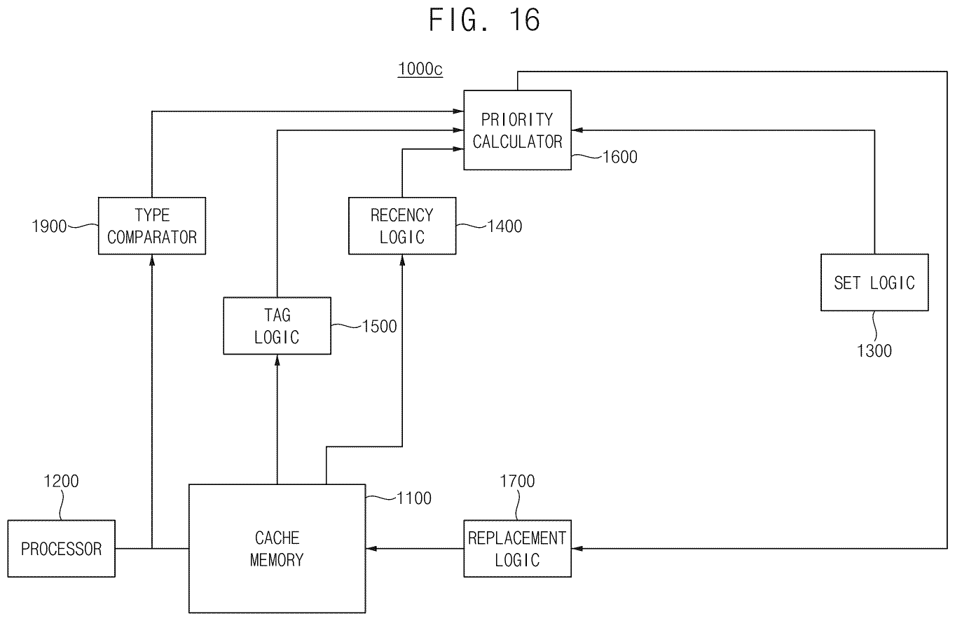

FIG. 16 is a block diagram illustrating an example of a cache data replacement system.

Referring to FIG. 16, a cache data replacement system 1000c may include a cache memory 1100, a processor 1200, a set logic 1300, a recency logic 1400, a tag logic 1500, a priority calculator 1600, a replacement logic 1700, and a type comparator 1900. In the cache data replacement system 1000c, the cache memory 1100, the processor 1200, the set logic 1300, the recency logic 1400, the tag logic 1500, the priority calculator 1600, and the replacement logic 1700 may be substantially the same as the cache memory 1100, the processor 1200, the set logic 1300, the recency logic 1400, the tag logic 1500, the priority calculator 1600, and the replacement logic 1700 in FIG. 2, respectively. Hereinafter, the descriptions repeated with or overlapping with descriptions of FIG. 2 will be omitted in the interest of brevity.

The type comparator 1900 may determine whether to bypass based on the access type. For example, if the access type of target data to be newly stored in the cache memory is the prefetch type, the type comparator 1900 may bypass the target data without storing the target data in the cache memory. For example, if the access type of target data to be newly stored in the cache memory is not the prefetch type, the type comparator 1900 may not bypass the target data. For example, if the target data is not bypassed, the replacement logic 1700 may perform a tag-age-based policy. For example, the replacement logic 1700 may perform the tag age-based policy of replacing the third cache data stored in the third way among the target ways with the target data based on the first reference value. For example, if the third way among the target ways has the largest first reference value, the replacement logic 1700 may replace the third cache data stored in the third way among the target ways with the target data. In other words, the type comparator 1900 may perform operation S360 in FIG. 15.

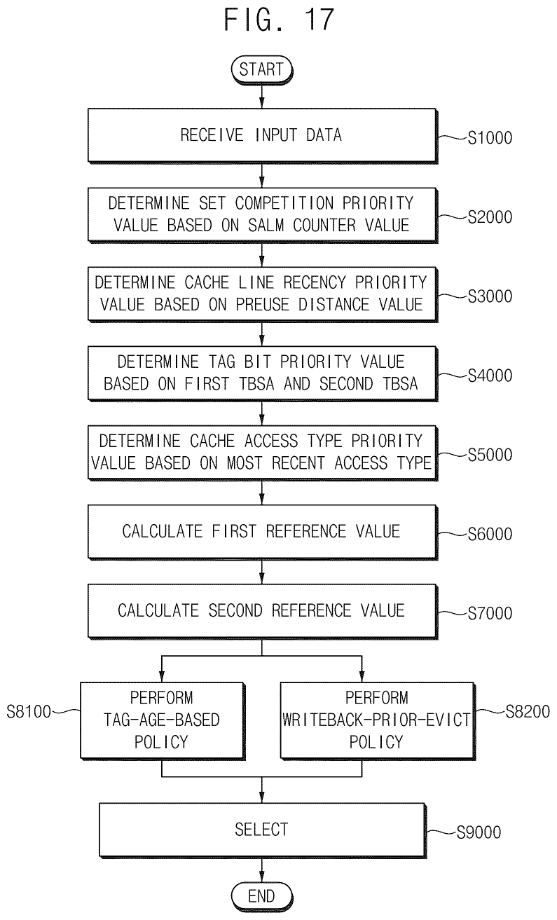

FIG. 17 is a flowchart illustrating an example of a method of replacing data in a cache memory.

Referring to FIG. 17, the method of replacing data in a cache memory may include operations S1000, S2000, S3000, S4000, S5000, S6000, S7000, S8100, S8200, and S9000. Operations S1000 to S4000 may be substantially the same as operations S110 to S140 in FIG. 1, respectively. Operation S5000 may be substantially the same as operation S250 in FIG. 13. Operations S6000 and S7000 may be substantially the same as operation S150 in FIG. 1 and the operation S260 in FIG. 13, respectively. Operations S8100 and S8200 may be substantially the same as operation S160 in FIG. 1 and operation S270 in FIG. 13, respectively. Hereinafter, the descriptions repeated with or overlapping with descriptions of FIGS. 1 and 13 will be omitted in the interest of brevity.

In some example implementations, as illustrated in FIG. 17, both the tag-age-based policy and the writeback-prior-evict policy may be performed, and one of the tag age-based policy and the writeback priority replacement policy may be selected (operation S9000). For example, after the tag age-based policy is performed for a plurality of first target data and the writeback-prior-evict policy is performed for a plurality of second target data, one policy having good instructions per cycle (IPC) performance may be selected. IPC means the number of instructions processed per clock cycle and is one of the measures for judging the performance of a processor.

In some example implementations, one of the tag age-based policy and the writeback-prior-evict policy may be performed for the target data. In this case, operation S9000 may be performed at the beginning of the operation.

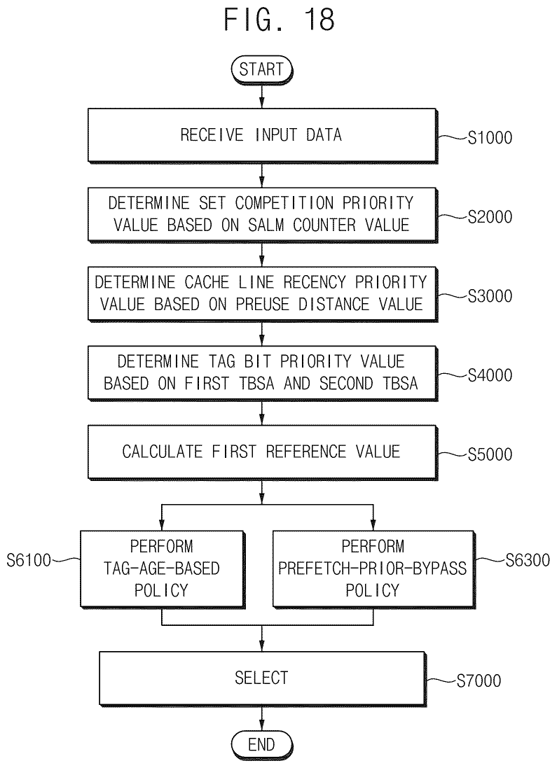

FIG. 18 is a flowchart illustrating an example of a method of replacing data in a cache memory.

Referring to FIG. 18, the method of replacing data in a cache memory may include operations S1000, S2000, S3000, S4000, S5000, S6100, S6300, and S7000. Operations S1000 to S5000 may be substantially the same as operations S110 to S150 in FIG. 1, respectively. Operations S6100 and S6300 may be substantially the same as operation S160 in FIG. 1 and operation S360 in FIG. 15, respectively. Hereinafter, the descriptions repeated with or overlapping with descriptions of FIGS. 1 and 15 will be omitted in the interest of brevity.

In some example implementations, as illustrated in FIG. 18, both the tag age-based policy and the prefetch-prior-bypass policy may be performed, and one of the tag age-based policy and the prefetch-prior-bypass policy may be selected (operation S7000). For example, after performing the tag-age-based policy for a plurality of first target data and performing the prefetch-prior-bypass policy for a plurality of third target data, one policy having good IPC performance may be selected.

In some example implementations, one of the tag-age-based policy and the prefetch-prior-bypass policy may be performed for the target data. In this case, operation S7000 may be performed at the beginning of the operation.

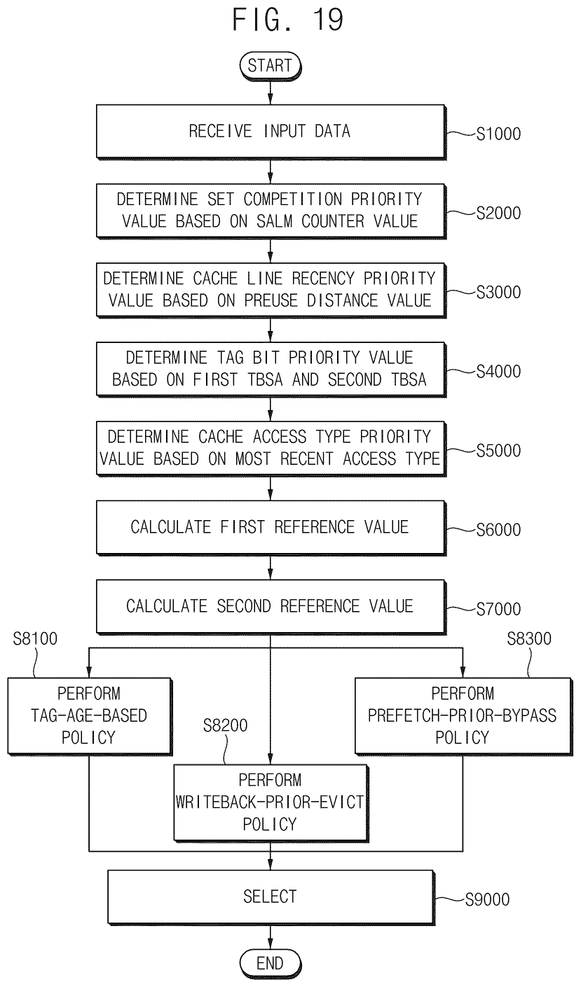

FIG. 19 is a flowchart illustrating an example of a method of replacing data in a cache memory.

Referring to FIG. 19, the method of replacing data in a cache memory may include operations S1000, S2000, S3000, S4000, S5000, S6000, S7000, S8100, S8200, S8300, and S9000. Operations S1000 to S4000 may be substantially the same as operations S110 to S140 in FIG. 1, respectively. Operation S5000 may be substantially the same as operation S250 in FIG. 13. Operations S6000 and S7000 may be substantially the same as operation S150 in FIG. 1 and operation S260 in FIG. 13, respectively. Operations S8100, S8200, and S8300 may be substantially the same as operation S160 in FIG. 1, operation S270 in FIG. 13, and operation S360 in FIG. 15, respectively. Hereinafter, the descriptions repeated with or overlapping with descriptions of FIGS. 1, 13 and 15 will be omitted in the interest of brevity.

The tag-age-based policy, the writeback-prior-evict policy, and the prefetch-prior-bypass policy may all be performed, and one of the tag-age-based policy, the writeback-prior-evict policy, and the prefetch-prior-bypass policy may be selected (operation S9000). For example, after performing the tag-age-based policy for a plurality of first target data, performing the writeback-prior-evict policy for a plurality of second target data, and performing the prefetch-prior-bypass policy for a plurality of third target data, one policy having the best IPC performance may be selected.

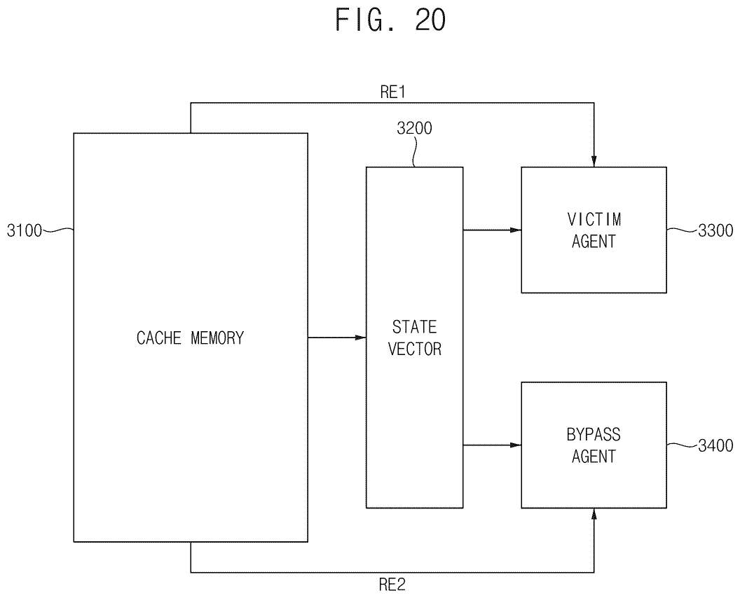

FIG. 20 is a diagram for describing an example of a method of replacing data in a cache memory.

Referring to FIG. 20, a cache memory 3100 may include a plurality of cache sets, and each cache set may include a plurality of ways. For example, reinforcement learning may be used to determine a way in which data to be replaced is stored among the plurality of ways. For example, reinforcement learning may be used to determine whether to bypass target data to be newly stored. Reinforcement learning is a type of machine learning, which means that a decision-making subject referred to as an agent learns an optimal decision through trial and error.

For example, when a state vector 3200 is input, a victim agent 3300 may perform reinforcement learning by applying a positive reward or negative reward to the victim agent 3300 through a first reward function RE1. After completing the reinforcement learning, the victim agent 3300 may determine the way in which the data to be replaced is stored.

For example, when the state vector 3200 is input, a bypass agent 3400 may perform reinforcement learning by applying a positive reward or negative reward to the bypass agent 3400 through a second reward function RE2. After completing the reinforcement learning, the bypass agent 3400 can determine whether to bypass the target data.

For example, the state vector 3200 may include information such as the byte offset of the target data, the access type of the target data, the SALM counter value of the target cache set, the most recent access type of the cache data, and the TBSA.

By performing the reinforcement learning, it was found that the SALM counter value of the target cache set, the TBSA, and the access type information of the target data are important among the information included in the state vector. The SALM counter value of the target cache set, the TBSA, and the access type information of the target data were used in the method of replacing data in a cache memory.

The example implementations may be applied to various electronic devices and systems that include the cache data replacement system. For example, the example implementations may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, etc.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The foregoing is illustrative of example implementations and is not to be construed as limiting thereof. Although some example implementations have been described, those skilled in the art will readily appreciate that many modifications are possible in the example implementations without materially departing from the novel teachings and advantages of the example implementations. Accordingly, all such modifications are intended to be included within the scope of the example implementations as defined in the claims. Therefore, it is to be understood that the foregoing is illustrative of various example implementations and is not to be construed as limited to the specific example implementations disclosed, and that modifications to the disclosed example implementations, as well as other example implementations, are intended to be included within the scope of the appended claims.

What is claimed is:

1. A method of replacing data in a cache memory, the cache memory including a plurality of cache sets, the plurality of cache sets including a plurality of ways, the method comprising:
receiving input data including an address of target data to be stored in the cache memory;
for a target cache set of the plurality of cache sets, determining a set competition priority value based on a set-access-count-since-last-miss (SALM) counter value, the SALM counter value representing a number of consecutive occurrences of a cache hit;
for each target way of a plurality of target ways included in the target cache set, determining a cache line recency priority value based on a preuse distance value, the preuse distance value representing a difference between a first cache access time point and a second cache access time point;
for each target way of the plurality of target ways, determining a tag bit priority value based on a first tag bit subset array (TBSA) and a second TBSA, the first TBSA representing a part of the address of the target data, the second TBSA representing a part of an address of cache data stored in each target way of the plurality of target ways;
for each target way of the plurality of target ways, calculating a first reference value based on the set competition priority value, the cache line recency priority value, and the tag bit priority value, the first reference value being used for selecting a first target way of the plurality of target ways; and
performing, based on the first reference value, a first operation based on a tag-age-based policy, the tag-age-based policy representing an operation that replaces first cache data stored in a first way among the plurality of target ways with the target data.

2. The method of claim 1, wherein determining the set competition priority value includes:
obtaining a comparison result based on comparing a target SALM counter value for the target cache set and at least one threshold value; and
obtaining the set competition priority value based on the comparison result.

3. The method of claim 1, wherein determining the cache line recency priority value includes:
increasing a global counter value based on each occurrence of a cache access;
storing the first cache access time point corresponding to the global counter value at a time point when a first cache access occurs, the first cache access being a most-recently occurring cache access among the plurality of cache accesses;
storing the preuse distance value that represents the difference between the second cache access time point and the first cache access time point, wherein the second cache access time point corresponds to the global counter value at a time point when a second cache access occurs, and the second cache access occurs before the first cache access; and
obtaining the cache line recency priority value based on the preuse distance value.

4. The method of claim 1, wherein determining the tag bit priority value includes:
obtaining a comparison result based on comparing a first-first TBSA and a first-second TBSA with a second-first TBSA and a second-second TBSA, respectively, the first-second TBSA being included in the first TBSA, the second-second TBSA being included in the second TBSA; and
obtaining the tag bit priority value based on the comparison result.

5. The method of claim 1, comprising:
determining that a cache miss for the target data occurs, and
based on determining that the cache miss for the target data occurs,
determining the set competition priority value,
determining the cache line recency priority value,
determining the tag bit priority value,
calculating the first reference value, and
performing the first operation based on the tag-age-based policy.

6. The method of claim 1, wherein the first reference value is a value obtained based on adding the tag bit priority value to a product of the set competition priority value and the cache line recency priority value.

7. The method of claim 1, comprising:
for each target way of the plurality of target ways, determining a cache access type priority value based on a most recent access type of cache data stored in the target way;
for each target way of the plurality of target ways, calculating a second reference value based on the set competition priority value, the cache line recency priority value, the tag bit priority value, and the cache access type priority value, the second reference value being used for selecting a second target way of the plurality of target ways; and
performing, based on the second reference value, a second operation based on a writeback-prior-evict policy, the writeback-prior-evict policy representing an operation that replaces second cache data stored in a second way among the target ways with the target data.

8. The method of claim 7, comprising selecting one of the tag-age-based policy and the writeback-prior-evict policy for a subsequent operation for the target data.

9. The method of claim 7, wherein the second reference value is a product of the first reference value and the cache access type priority value.

10. The method of claim 1, comprising:
performing a second operation based on a prefetch-prior-bypass policy, wherein the prefetch-prior-bypass policy represents
an operation in which the target data is bypassed without being stored based on an access type of the target data being a prefetch type, and
an operation in which third cache data stored in a third way among the plurality of target ways is replaced with the target data based on the access type of the target data not being the prefetch type.

11. The method of claim 10, comprising selecting one of the tag-age-based policy and the prefetch-prior-bypass policy for a subsequent operation for the target data.

12. The method of claim 1, wherein the input data includes information on an access type of the target data.

13. A cache data replacement system comprising:
a cache memory including data array, the data array including a plurality of cache sets, the plurality of cache sets including a plurality of ways;
a processor configured to provide target data and input data, the input data including an address of the target data, the target data being data to be stored in the cache memory;
a set logic circuit configured to determine a set competition priority value for a target cache set of the plurality of cache sets based on a set-access-count-since-last-miss (SALM) counter value, the SALM counter value representing a number of consecutive occurrences of a cache hit;
a recency logic circuit configured to determine a cache line recency priority value for each target way of a plurality of target ways included in the target cache set based on a preuse distance value, the preuse distance value representing a difference between a first cache access time point and a second cache access time point;
a tag logic circuit configured to determine a tag bit priority value for each target way of the plurality of target ways based on a first tag bit subset array (TBSA) and a second TBSA, the first TBSA representing a part of the address of the target data, the second TBSA representing a part of an address of cache data stored in each target way of the plurality of target ways;
a priority calculator configured to calculate a first reference value for each target way of the plurality of target ways based on the set competition priority value, the cache line recency priority value, and the tag bit priority value, the first reference value being used for selecting a first target way of the plurality of target ways; and
a replacement logic circuit configured to perform, based on the first reference value, a first operation based on a tag-age-based policy, the tag-age-based policy representing an operation that replaces first cache data stored in a first way among the plurality of target ways with the target data.

14. The cache data replacement system of claim 13, wherein the cache memory includes:
a tag array configured to store a tag bit of cache data stored in each target way of the plurality of target ways; and
a status array configured to store a most recent access type of the cache data stored in each target way of the plurality of target ways.

15. The cache data replacement system of claim 13, comprising:
a type logic circuit configured to determine a cache access type priority value for each target way of the plurality of target ways based on a most recent access type of cache data stored in the target way,
wherein the priority calculator is configured to calculate a second reference value for each target way of the plurality of target ways based on the set competition priority value, the cache line recency priority value, the tag bit priority value, and the cache access type priority value, the second reference value being used for selecting a second target way of the plurality of target ways, and
wherein the replacement logic circuit is configured to perform, based on the second reference value, a second operation based on a writeback-prior-evict policy, the writeback-prior-evict policy representing an operation that replaces second cache data stored in a second way among the plurality of target ways with the target data.

16. The cache data replacement system of claim 13, comprising:
a type comparator configured to determine whether to bypass of the target data based on an access type of the target data,
wherein, based on the access type of the target data being a prefetch type, the type comparator is configured to bypass the target data without storing the target data, and
wherein, based on the access type of the target data not being the prefetch type, the replacement logic circuit is configured to replace third cache data stored in a third way among the plurality of target ways with the target data.

17. The cache data replacement system of claim 13, comprising:
a SALM counter configured to store the SALM counter value;
a global counter configured to store a global counter value that is increased based on each occurrence of a cache access;
a tag age vector storage configured to store the first cache access time point corresponding to the global counter value at a time point when a first cache access occurs, the first cache access being a most-recently occurring cache access among the plurality of cache accesses; and
a preuse distance vector storage configured to store the preuse distance value that represents the difference between the second cache access time point and the first cache access time point, wherein the second cache access time point corresponds to the global counter value at a time point when a second cache access occurs, and the second cache access occurs before the first cache access.

18. A method of replacing data in a cache memory, the cache memory including a plurality of cache sets, the plurality of cache sets including a plurality of ways, the method comprising:
receiving input data including an address of target data to be stored in the cache memory;
for a target cache set of the plurality of cache sets, obtaining a first comparison result based on comparing a target set-access-count-since-last-miss (SALM) counter value and at least one threshold value, the target SALM counter value being a number of consecutive occurrences of a cache hit;
obtaining a set competition priority value based on the first comparison result;
for each target way of a plurality of target ways included in the target cache set, increasing a global counter value based on each occurrence of a cache access;
storing a first cache access time point corresponding to the global counter value at a time point when a first cache access occurs, the first cache access being a most-recently occurring cache access among the plurality of cache accesses;
storing a preuse distance value that represents a difference between a second cache access time point and the first cache access time point, wherein the second cache access time point corresponds to the global counter value at a time point when a second cache access occurs, and the second cache access occurs before the first cache access;
obtaining a cache line recency priority value based on the preuse distance value;
for each target way of the plurality of target ways, obtaining a second comparison result based on comparing a first tag-bit-subset-array (TBSA) and a second TBSA, the first TBSA representing a part of an address of the target data, the second TBSA representing a part of an address of cache data stored in each target way of the plurality of target ways;
for each target way of the plurality of target ways, obtaining a tag bit priority value based on the second comparison result;
for each target way of the plurality of target ways, calculating a first reference value based on the set competition priority value, the cache line recency priority value, and the tag bit priority value, the first reference value being used for selecting a first target way of the plurality of target ways; and
performing a tag-age-based policy based on the first reference value, the tag-age-based policy representing an operation that replaces first cache data stored in a first way among the plurality of target ways with the target data.
